(19) United States
(12) Patent Application Publication
(10) Pub. No.: US 2014/0011503 A1
(43) Pub. Date: Jan. 9, 2014

(54) WIRELESS COMMUNICATION NETWORK AREA DESIGNING METHOD, COMPUTER READABLE NON-TRANSITORY MEDIUM AND WIRELESS COMMUNICATION NETWORK AREA DESIGNING DEVICE

(71) Applicant: HAIQING DU, Yokohama (JP)

(72) Inventor: HAIQING DU, Yokohama (JP)

(73) Assignee: FUJITSU LIMITED, Kawasaki-shi (JP)

(21) Appl. No.: 13/900,793

(22) Filed: May 23, 2013

(30) Foreign Application Priority Data
Jul. 6, 2012 (JP) 2012-152369

(51) Int. Cl. H04W 16/24

(52) U.S. Cl. CPC H04W 16/24
USPC 455/448

(57) ABSTRACT

A wireless communication network area designing method for placement and dimensioning of wireless base station formed by a three-sector configuration is provided. The method includes reducing cell radius of existing sites to half, adding a new site to an intermediate point between adjacent existing sites, aligning the antenna azimuth angle of the new site to that of the existing sites, and setting a cell radius of the new site to be the same as the cell radius of the existing sites in the reduced cell radius.

### CROSS-REFERENCE TO RELATED APPLICATIONS

This application is based upon and claims the benefit of priority of the prior Japanese Patent Application No. 2012-152369, filed on Jul. 6, 2012, the entire contents of which are incorporated herein by reference.

### FIELD

Embodiments discussed in the specification relate to placement and dimensioning of wireless base stations in a wireless communication network area.

### BACKGROUND

Methods of increasing traffic capacity in a mobile communication network include, for example, addition of a frequency band, change of a modulation/demodulation method, increase in the number of sectors forming a cell, and addition of installation sites of wireless base stations. The installation sites of wireless base stations are also described as “sites” in the specification and appended drawings.

In a known technique related to control of a cell in a mobile communication system, a mobile device detects whether the position of itself after a base station changes the shape of cells is out of the cells or not on the basis of information related to a change in the shape of cells notified from the base station before it becomes out of the cells. The mobile device notifies the base station of the detection result, and the base station stops the change in the cell shapes on the basis of the detection result notified from the mobile device.

In another known related technique, a call zone is enlarged/reduced according to increase/decrease of traffic, and the number of call channels is changed. As another related art, a wireless control device and a communication method of automatically updating an antenna pattern so as to follow a change in the state of a service area while reducing frequency interference are provided.

In still another known related technique, it is known that a cell configuration is changed by switching connections between a plurality of base station apparatus and a plurality of sector antennae based on values of predetermined parameters which are obtained from outputs of the plurality of sector antennae.

In another related art, it is known that a base station is provided with a directivity changing circuit capable of arbitrarily changing the directivity in a vertical plane of an antenna and a control device which controls the directivity changing circuit. With the configuration, the size of a zone in which the base station can communicate with a mobile station can be easily changed as necessary. It is also known that, by controlling the zones of a plurality of base stations in a lump, in the case where a number of calls are generated, setting of the zone according to the generation of calls is dynamically controlled.

In another related art, it is also known that, by changing the cell radius or cell area by controlling transmission power of a base station in accordance with fluctuations in traffic among places with time, a demand for communication by small number of cells is addressed. In another related art, it is known to take a countermeasure against wave interference between base stations in consideration of communication capability of the other part of wireless communication while maintaining the degree of freedom of radio design of a cognitive radio base station. The presence or absence of interference of electric waves related to a plurality of wireless media which provide communication areas of different sizes is determined and, in the case where a wireless medium providing the largest communication area has interference, the transmission power of the wireless medium is reduced to the minimum level at which wireless communication can be performed.

Related art is disclosed in Japanese National Publication of International Patent Applications No. 2003-87840, 5-259967, 2007-36487, 2007-166353, 8-47043, 2004-343807 and 2008-252513.

### SUMMARY

In accordance with an aspect of the method, there is provided a wireless communication network area designing method for determining the location of a site in which a wireless base station is to be installed in an area in which cells are formed by a three-sector configuration. The method includes reducing cell radius of existing sites to the half, adding a new site to an intermediate point between adjacent existing sites, aligning an antenna azimuth angle of the new site to antenna azimuth angle of the existing sites, and setting a cell radius of the new site to be the same as the cell radius of the existing sites in the reduced cell radius.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

FIG. 1A is a diagram illustrating an example of a wireless communication network.

FIG. 1B is a diagram illustrating a sector configuration of a cell.

FIG. 2A is a diagram illustrating a first example of a wireless communication network area designing method.

FIG. 2B is a diagram illustrating a first example of a wireless communication network area designing method.

FIG. 3A is a diagram illustrating the first example of the wireless communication network area designing method.

FIG. 3B is a diagram illustrating the first example of the wireless communication network area designing method.

FIG. 4 is a diagram illustrating the first example of the wireless communication network area designing method.

FIG. 5 is a diagram illustrating an example of a hardware configuration of a wireless communication network area designing device.

FIG. 6 is a diagram illustrating a first example of the functional configuration of the wireless communication network area designing device.

FIG. 7 is a diagram illustrating an example of site information.

FIG. 8 is a diagram illustrating an example of traffic capacity information.

FIG. 9 is a diagram illustrating an example of the amount of traffic information.

FIG. 10 is a diagram illustrating a first example of operations of the wireless communication network area designing device.

FIG. 11A is a diagram illustrating a work of designing a wireless communication network area.

FIG. 11B is a diagram illustrating a work of designing a wireless communication network area.

FIG. 12 is a diagram illustrating the work of designing the wireless communication network area.

FIG. 13A is a diagram illustrating a second example of the wireless communication network area designing work.

FIG. 13B is a diagram illustrating a second example of the wireless communication network area designing work.

FIG. 14 is a diagram illustrating a second example of the functional configuration of the wireless communication network area designing device.

FIG. 15 is a diagram illustrating a second example of the operations of the wireless communication network area designing device.

### DESCRIPTION OF EMBODIMENTS

In conventional site placement and dimensioning design, one of the method is that a new site is arbitrary added according to a traffic increase place. Due to this method, placement and dimensioning of sites and cell radii is lack of regularity. As a consequence, designing overlaps among cells is complicated. The object of this method, a non-volatile data medium storing a computer program, or a device disclosed in the specification is to facilitate seamless cell designing in which the number of sites and the number of gaps among cells is optimized at the time of adding a site. Another object of the method, the non-volatile data medium storing a computer program, or the device disclosed in the specification is to effectively use existing sites including both its location and facility.

### 1. First Embodiment

1.1 Wireless Communication Network

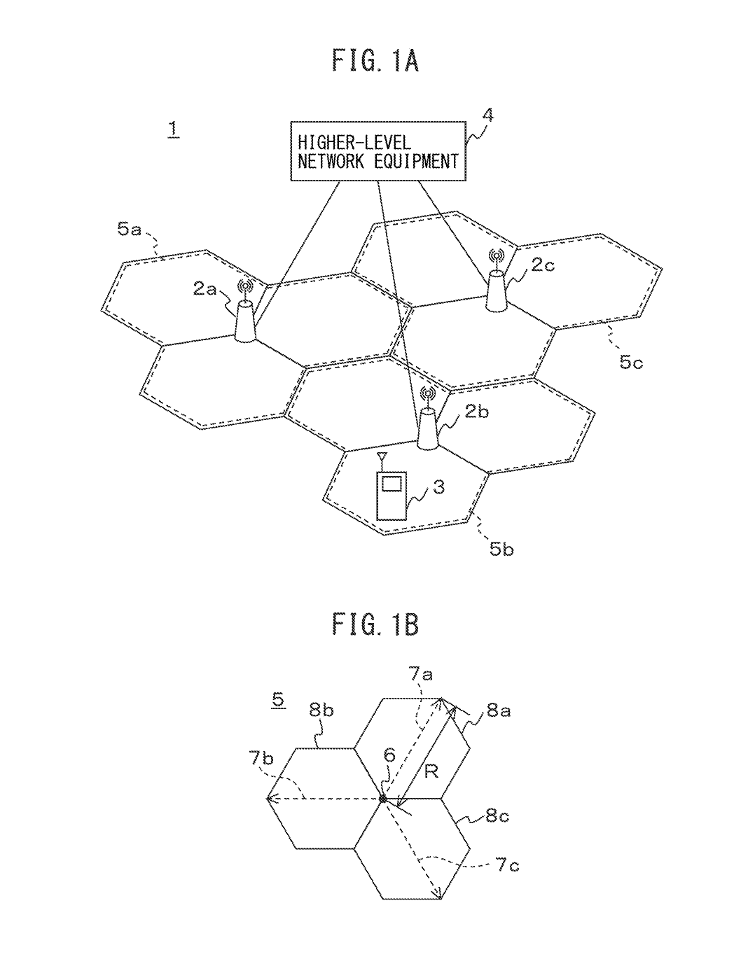

Hereinafter, preferred embodiments will be described with reference to the attached drawings. A wireless communication network area designing method disclosed in the specification is used to increase installation sites of wireless base stations in a wireless communication network depicted in FIG. 1A. In the following description and the attached drawings, the wireless communication network area designing method is also written as “area designing method”. A network is also written as “NW”.

A wireless communication network 1 includes wireless base stations 2a to 2c, a mobile station 3, and a higher-level network equipment 4. Reference numerals 5a to 5c indicate cells covered by the wireless base stations 2a to 2c, respectively. In the following description and the attached drawings, the wireless base stations 2a to 2c and the cells 5a to 5c are also generically described as “wireless base station 2” and “cell 5”.

The higher-level network equipment 4 may be an network element which controls the wireless base station 2 and relays traffic between the wireless base station 2 and a stationary switching network. For example, in the case where the wireless communication network 1 is a third-generation mobile communication system standardized with 3GPP (Third Generation Partnership Project), the higher-level network equipment 4 may be an RNC (Radio Network Controller). In the case where the wireless communication network 1 is a communication system conformed to the LTE (Long Term Evolution) method, the higher-level network equipment 4 may be an MME (Mobility Management Entity). The higher-level network equipment 4 may be an S-GW (Serving System Architecture Evolution Gateway). The method, a computer program, and a device disclosed in the specification are widely applicable also to network designing in communication systems of other systems as long as a network is a wireless communication network using a cell of a three-sector configuration.

FIG. 1B is a diagram illustrating a sector configuration of the cell 5 in the wireless communication network 1. A plot dot drawn in the attached drawings indicate a site. The antenna azimuth angle of the wireless base station 2 installed in a site 6 is directed to arrows 7a to 7c. The wireless base station 2 has the capability to process 3 sectors and the radio wave of these 3 sectors is transmitted/received to/from the antenna azimuth angles 7a to 7c, so that the cell 5 has a so-called “three-sector configuration” made by three sectors 8a to 8c. In the following description, the radius of a cell in an existing site before adding a new site will be described as “R”.

1.2 Wireless Communication Network Area Designing Method

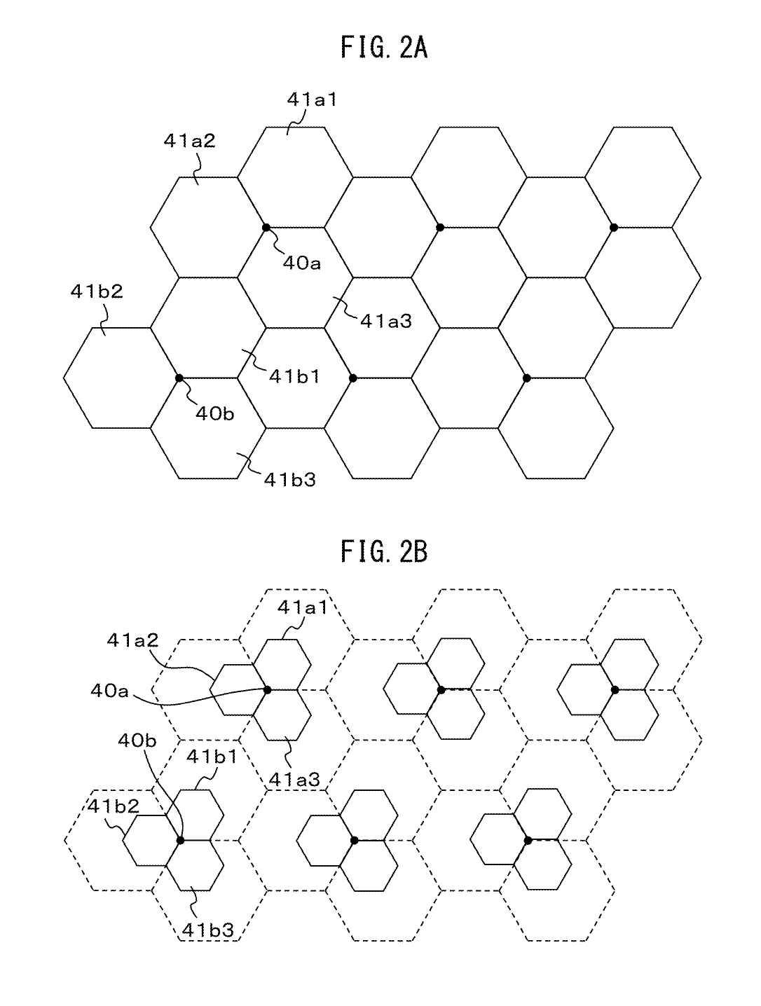

Hereinafter, referring to FIGS. 2A and 2B, FIGS. 3A and 3B, and FIG. 4, the first example of the area designing method will be described. FIG. 2A illustrates a state before addition of sites to a target area to which new sites are to be added. Sites 40a and 40b are existing sites, sectors 41a1 to 41a3 constitute the cell of the site 40a, and sectors 41b1 to 41b3 constitute the cell of the site 40b.

At the time of adding a new site, the cell radius of each of the existing sites 40a and 40b is reduced to the length of the half. That is, the cell radius of each of the existing sites 40a and 40b becomes “R/2”. FIG. 2B illustrates a state where the cell radius of the existing sites 40a and 40b is “R/2” and the size of the sectors 41a1 to 41a3 and the sectors 41b1 to 41b3 is reduced. Reduction of the cell radius of the existing sites 40a and 40b may be realized by, for example, decreasing the transmission power of the wireless base station 2. By reducing the cell radius by decreasing the transmission power, the existing antenna can be effectively used.

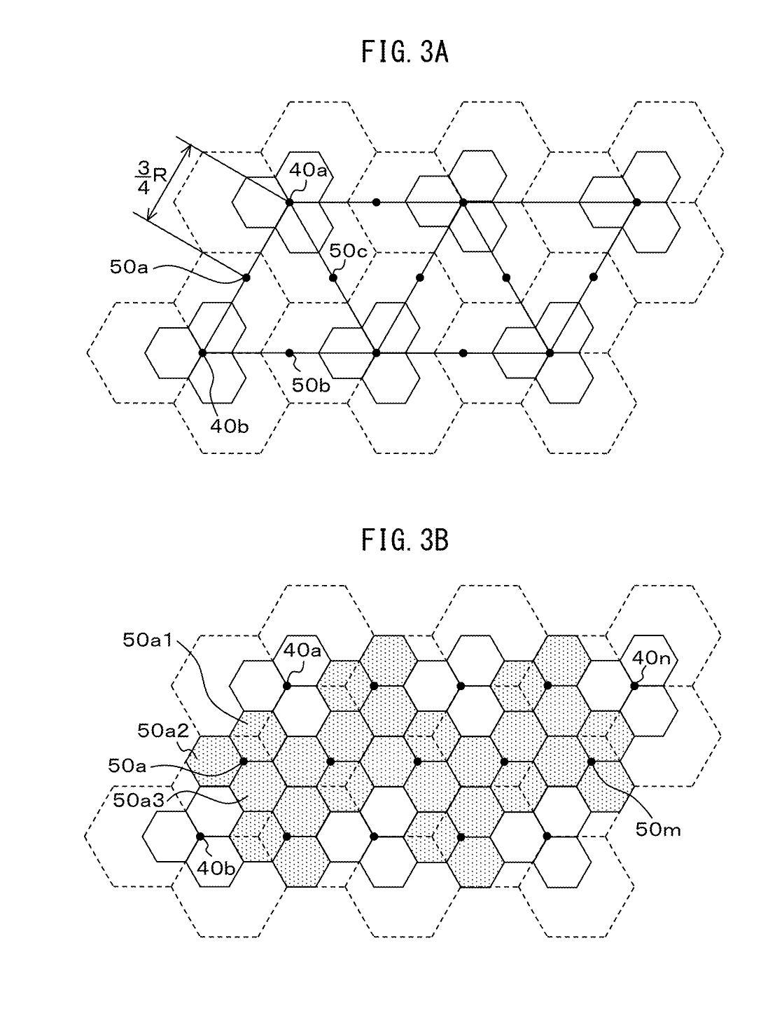

Subsequently, the installation position of a new site is determined. As depicted in FIG. 3A, the positions of new sites 50a, 50b, 50c, . . . are set in intermediate points of the neighboring existing sites 40a, 40b, . . . Specifically, the installation position of a new site is set in a position on a straight line connecting a pair of adjacent existing sites and far from the existing sites by equal distances. For example, the position of the new site 50a is set in a position on a straight line connecting the pair of adjacent existing sites 40a and 40b and far from the existing sites 40a and 40b by equal distances. The distance between each of the existing sites 40a and 40b adjacent to the new site 50a and the new site 50a is (¾)×R.

Next, the antenna azimuth angles in the new sites 50a, 50b, 50c, . . . . are determined. The antenna azimuth angles in the new sites 50a, 50b, 50c, . . . are aligned to those of the existing sites 40a, 40b, . . . For example, the antenna azimuth angles directed in three directions in the new sites 50a, 50b, 50c, . . . are set to the same as those of the existing sites 40a, 40b, . . . The actual orientation of an antenna is finely adjusted at each installation position. The orientations of the antennas of the new sites 50a, 50b, and 50c and those of the antennas of the existing sites 40a and 40b are determined so as to be almost the same on the basis of the orientations of the antennas of the existing sites 40a and 40b.

The cell radius in the new sites 50a, 50b, 50c, . . . is also determined. The cell radius in the new sites 50a, 50b, and 50c is R/2 which is the same as that of the existing sites 40a and 40b after the cell radius is reduced. For example, the cell radius may be adjusted by adjusting the transmission power of the wireless base station 2 installed in a newly provided site. The cell radius may be selected by selecting an antenna having proper gain at the time of newly providing the wireless base station 2.

FIG. 3B illustrates sectors constituting a cell of a new site whose installation position, antenna azimuth angle, and cell radius are determined by the above process. For example, sectors 50a1, 50a2, and 50a3 constitute the cell of the new site 50a. The order of the processes of reduction of the cell radius of the existing site, the position decision of a new site, and determination of the antenna azimuth angles and the cell radius may be different from the above-described order. The order of executing the processes is not limited.

After that, whether the design value of the traffic capacity in a target area in which a new site is added is equal to or larger than desired amount of traffic is determined. For example, whether the design value in each of parts in the target area is equal to or larger than a target value is determined. The target value may be designated on the basis of increase ratios before and after addition of a site or the amount of traffic after addition of a site. For example, by determining whether a measurement value or a prediction value of traffic generated in each of parts in a target area is equal to or less than the design value of the traffic capacity, whether the design value of the traffic capacity is equal to or larger than desired amount of traffic may be determined.

In the case where the design value is equal to or larger than the expected amount of traffic in all of the target area, the designing of the wireless communication network area is finished. In the case where the design value is not equal to or larger than the desired amount of traffic in any area in the target area, addition of a site is recursively repeated in an area where the design value is not equal to or larger than the desired amount of traffic. At this time, both a new site added in the preceding process and an existing site are regarded as existing sites, and reduction of the cell radius and determination of the installation position, the antenna azimuth angles, and the cell radius of a new site are recursively repeated.

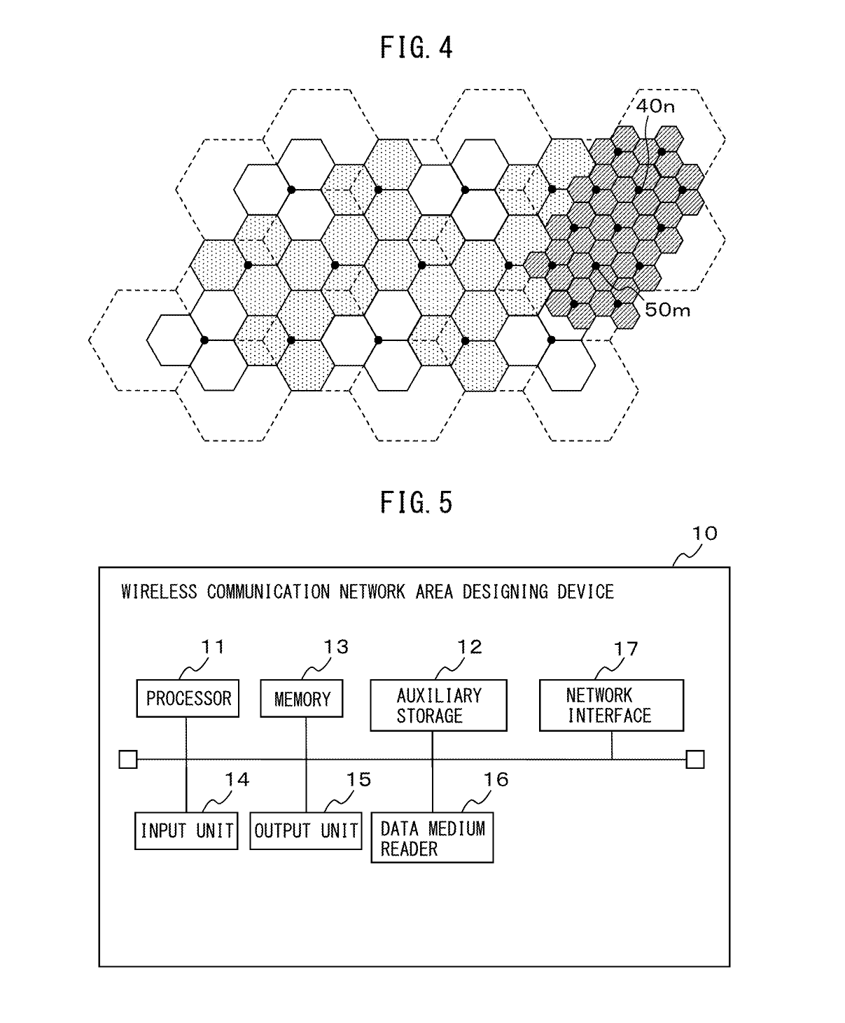

For example, in the example of FIG. 3B, it is assumed that the design value of the traffic capacity in the coverage of an existing site 40n and a new site 50m is not equal to or larger than the amount of traffic. In this case, the cell radius of the existing site 40n and the new site 50m is reduced from R/2 to R/4. New sites each having a cell radius of R/4 are added to the points which are on straight lines connecting the sites 40n and 50m and adjacent sites and apart from the sites 40n and 50m by (⅜)×R. FIG. 4 illustrates a state of the target area after the new sites are added.

After that, until the design value of capacity becomes equal to or larger than the expected amount of traffic in all of the target area, reduction of the cell radius and determination of the installation position, the antenna azimuth angles, and the cell radius of a new site are repeated.

1.3 Wireless Communication Network Area Designing Device

Hereinafter, a wireless communication network area designing device for executing the area designing method will be described. In the following description and the appended drawings, the wireless communication network area designing device is also described as “area designing device”.

1.3.1 Hardware Configuration

FIG. 5 is a diagram illustrating an example of the hardware configuration of an area designing device 10. The area designing device 10 has a processor 11, an auxiliary storage 12, a memory 13, an input unit 14, an output unit 15, a medium reader 16, and a network interface 17. The hardware configuration illustrated in FIG. 5 is merely an example for explaining the embodiment. As the area designing device 10 described in the specification, any other hardware configuration may be employed as long as it executes the above-described area designing method.

The processor 11 executes a computer program stored in the auxiliary storage 12, thereby executing information process according to the area designing method. In the auxiliary storage 12, an area designing program as a computer program for making the processor 11 execute the information process according to the area designing method is stored. The auxiliary storage 12 may include a non-volatile storage for storing the area designing program and data used to execute the program, a read only memory (ROM), and a hard disk. In the memory 13, a program presently executed by the processor and data temporarily used by the program is stored. The memory 13 may include a random access memory (RAM).

The input unit 14 is an input device which accepts input operation by the user. The input unit 14 may be, for example, a keypad, a keyboard, a pointing device, a touch panel, or the like. The output unit 15 is an output device which outputs a signal processed by the area designing device 10. For example, the output unit 15 may be a display device which visibly displays information. The output unit 15 may be, for example, a display device such as a liquid crystal display, a CRT (Cathode Ray Tube) display, an organic electroluminescence display, or the like. The output unit 15 may be a speaker for outputting a sound signal and a drive circuit for the speaker.

The medium reader 16 is an input device which reads data stored in a computer-readable portable recording medium. The medium reader 16 may be, for example, an access device to a CD-ROM drive device, a DVD-ROM drive device, a flexible disk drive device, a CD-R drive device, a DVD-R drive device, an MO drive device, and a flash memory device. The network interface 7 is connected to a communication network and transmits/receives data to/from another computer or communication device via the communication network.

The area design program may be stored in a machine-readable recording medium. The area design program stored in the machine-readable recording medium may be read by the medium reader 16 and installed in the auxiliary storage 12. The area design program may be downloaded from a program provider via the network interface and installed in the auxiliary storage 12.

1.3.2 Functional Configuration

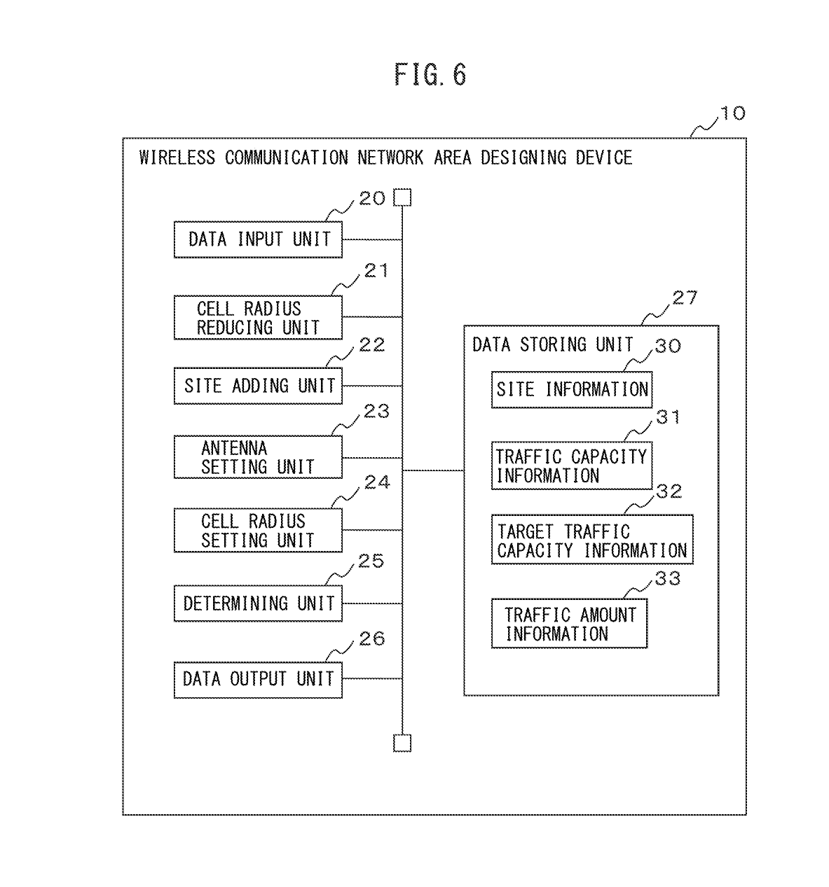

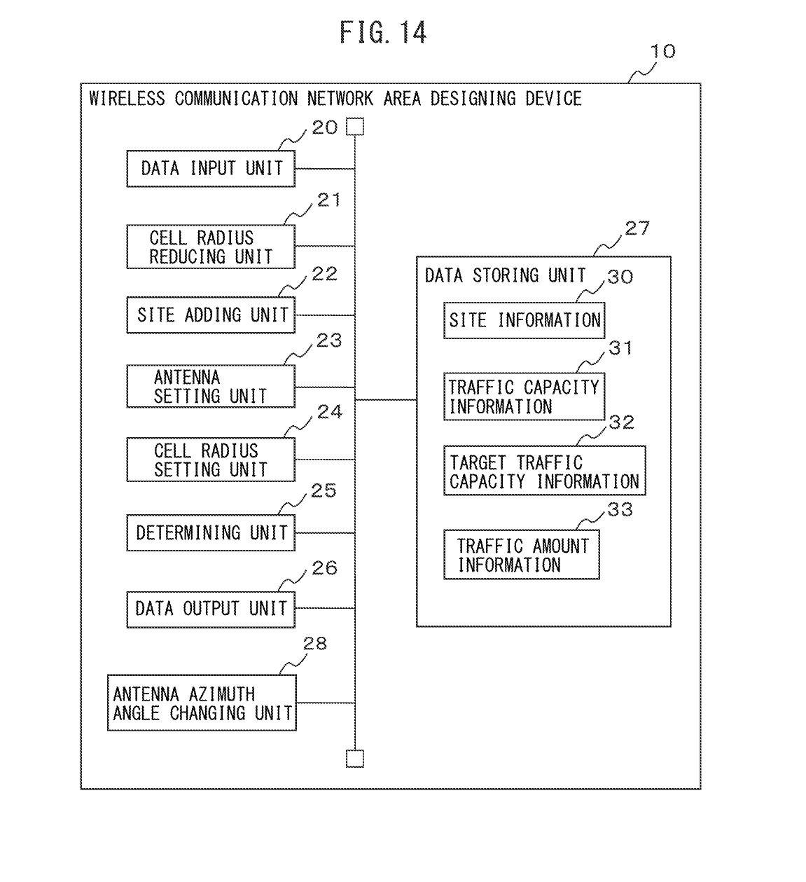

Subsequently, functions realized by the hardware configuration will be described. FIG. 6 is a diagram for explaining the first example of the functional configuration of the area designing device 10. The functional configuration diagram of FIG. 6 mainly illustrates components related to functions to be described later in the specification of the area designing device 10. The area designing device 10 may include components other than the components depicted in the diagram. This explanation similarly applies to the functional configuration diagram of FIG. 14.

The area designing device 10 has a data input unit 20, a cell radius reducing unit 21, a site adding unit 22, an antenna setting unit 23, a cell radius setting unit 24, a determining unit 25, a data output unit 26, and a data storing unit 27.

The data input unit 20 receives site information 30, current traffic capacity information 31, target traffic capacity information 32, and the amount of traffic information 33 used for execution of the area designing program.

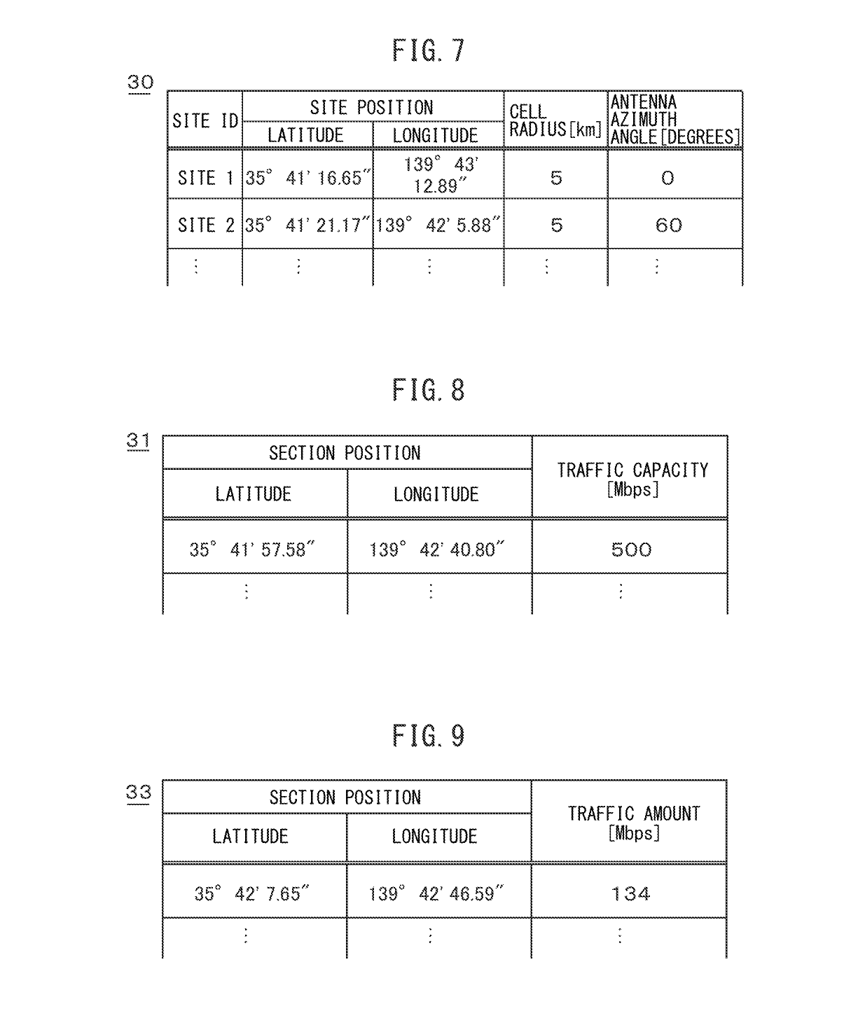

The site information 30 includes information regarding the installation position, cell radius, and antenna azimuth angle of an existing site. FIG. 7 is a diagram illustrating an example of the site information 30. The site information 30 includes information elements “site ID”, “site position”, “cell radius”, and “antenna azimuth angle”. The site ID is the identifier of each of existing sites. The information element “site position” indicates latitude and longitude of the position of each of the existing sites. The information element “cell radius” indicates the cell radius in each of the existing sites. The information element “antenna azimuth angle” denotes the antenna azimuth angle of one of three antennas oriented in three directions in each of the existing sites. For example, the second line in FIG. 7 indicates that the position of an existing site whose site ID is “site 2” is at “35 degrees 41 minutes 21.17 seconds” north latitude and “139 degrees 42 minutes 5.88 seconds” east longitude and the cell radius is “5 km”. The antenna azimuth angle of the existing site is turned by 60 degrees in the clockwise direction from the reference azimuth angle.

The traffic capacity information 31 includes information on the design value of the present traffic capacity in a target area to which a new site is added. FIG. 8 is a diagram illustrating an example of the traffic capacity information 31. The traffic capacity information 31 includes information elements “section position” and “traffic capacity”. The information element “section position” indicates latitude and longitude of each of unit sections in a target area. The information element “traffic capacity” indicates traffic capacity in each of the unit sections in the present site arrangement. For example, the first line in FIG. 8 indicates that the traffic capacity of a unit section at “35 degrees 41 minutes 57.58 seconds” north latitude and “139 degrees 42 minutes 40.80 seconds” east longitude is “500 Mbps”.

The target traffic capacity information 32 includes information regarding the target value of a traffic capacity realized in a target area. The target traffic capacity information 32 may include a target value of a traffic capacity in each unit section. In this case, the data structure of the target traffic capacity information 32 may be similar to that of the traffic capacity information 31. As the target traffic capacity information 32, target of the traffic capacity in each unit section may be designated in the form of the ratio to a design value of the present traffic capacity. The target of the traffic capacity in this case is designated as, for example, “xx times of the design value of the present traffic capacity”.

The traffic information 33 includes information of the amount of traffic generated in a target area. FIG. 9 is a diagram illustrating an example of the traffic information 33. The information element “section position” indicates the latitude and longitude of each of unit sections in a target area. The information element “amount of traffic” indicates the amount of traffic generated in each unit section. The amount of traffic may be a traffic measurement value or a prediction value of traffic expected. The site information 30, the traffic capacity information 31, the target traffic capacity information 32, and the traffic information 33 entered is stored in the data storing unit 27. For example, the first line in FIG. 9 indicates that the amount of traffic of a unit section at “35 degrees 42 minutes 7.65 seconds” north latitude and “139 degrees 42 minutes 46.59 seconds” east longitude is “134 Mbps”.

The cell radius reducing unit 21, the site adding unit 22, the antenna setting unit 23, and the cell radius setting unit 24 perform addition of a new site, setting of an existing site and the new site accompanying the addition in accordance with the area designing method. The cell radius reducing unit 21 determines the cell radius of the existing site by reducing the cell radius of the existing site to the half on the basis of the information on the cell radius designated by the site information 30. The site adding unit 22 determines the installation position of a new site on the basis of the position information of the existing site designated by the site information 30. The antenna setting unit 23 determines the antenna azimuth angle of the new site on the basis of the information on the antenna azimuth angle designated by the site information 30. The cell radius setting unit 24 determines the cell radius of the new site in accordance with the cell radius of the existing site.

The determining unit 25 compares the design value of the amount of traffic in the target area with a target value. The determining unit 25 compares the design value of the traffic capacity in the target area with the amount of traffic designated by the traffic information 33. The determining unit 25 controls the operation of a processor so that addition of a new site, setting of an existing site and the new site accompanying the addition are executed in the case where the design value of traffic capacity is smaller than the target value or the amount of traffic. In the case where designing of the location of the site is completed, the data output unit 26 outputs design data.

The operation of the data input unit 20 is realized by cooperation of the input unit 14 and/or the medium reader 16 and the processor 11 depicted in FIG. 5. The operation of the cell radius reducing unit 21, the site adding unit 22, the antenna setting unit 23, the cell radius setting unit 24, and the determining unit 25 is realized by the processor 11. The operation of the data output unit 26 is realized by cooperation of the output unit 15 and the processor 11. The storage area in the data storing unit 27 is provided in the auxiliary storage 12 or the memory 13.

1.3.3 Operations

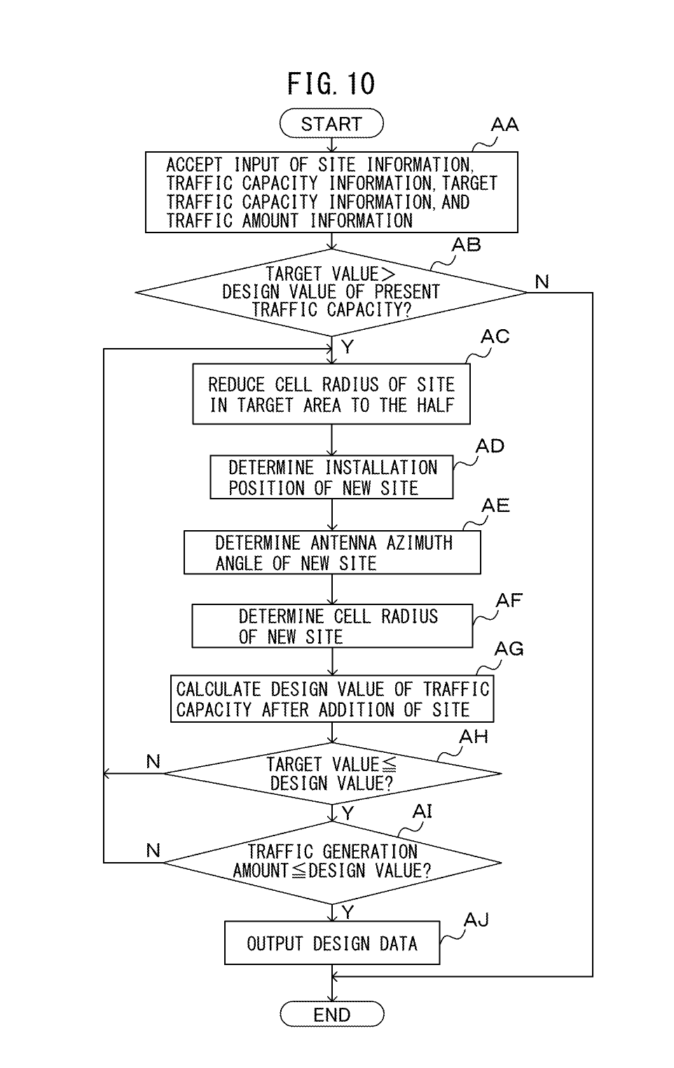

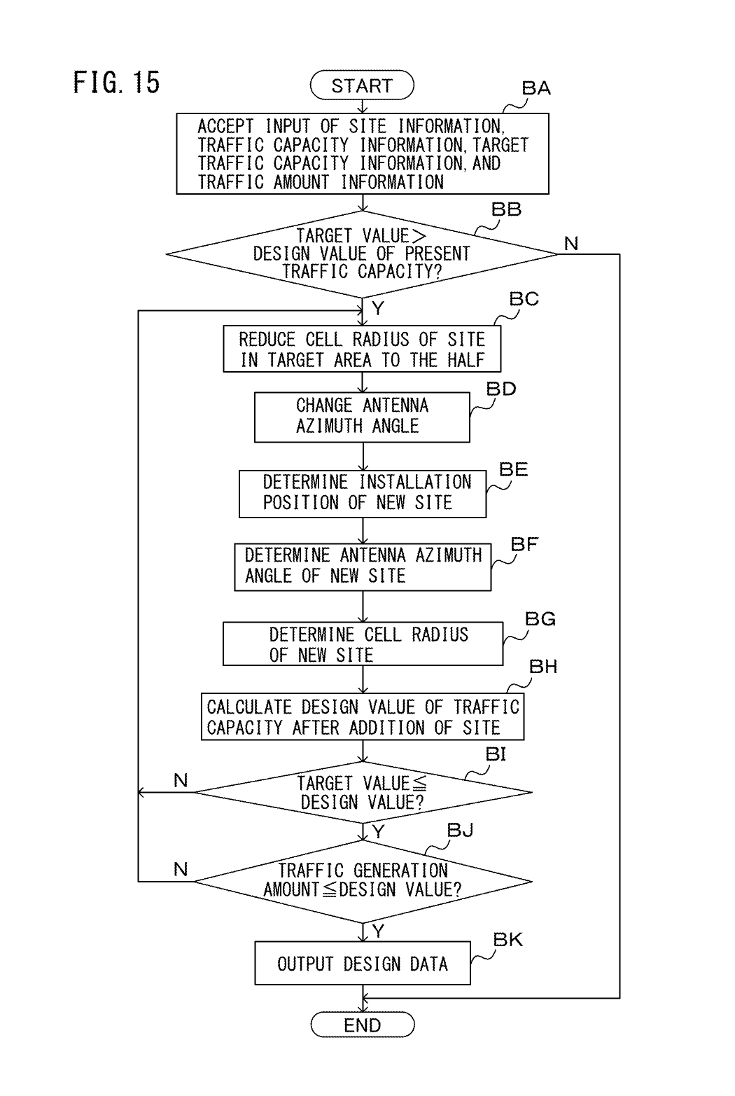

The first example of the operations of the area designing device 10 will be described with reference to FIG. 10. A series of operations described with reference to FIG. 10 may be interpreted as a method including plural steps. In this case, “operation” may be regarded as “step”. The operations depicted in FIG. 15 may be similarly interpreted. In operation AA, the input unit 14 accepts an input of the site information 30, the traffic capacity information 31, the target traffic capacity information 32, and the traffic information 33.

In operation AB, the determining unit 25 determines whether the present traffic capacity in the target area is smaller than the target value or not. In the case where the present traffic capacity is smaller than the target value (Y in operation AB), the routine advances to operation AC. In the case where the present traffic capacity is equal to or larger than the target value (N in operation AB), the operation is finished.

In operation AC, the cell radius reducing unit 21 reduces the cell radius of the existing site in the target area to the half. In operation AD, the site adding unit 22 determines the installation position of a new site. In operation AE, the antenna setting unit 23 determines the antenna azimuth angle of the new site. In operation AF, the cell radius setting unit 24 determines the cell radius of the new site. The order of the operations AC to AF is not limited to the example of FIG. 10. The operations AC to AF may be executed in any order.

In operation AG, the determining unit 25 calculates the design value of the amount of traffic in the target area after adding the site. In operation AH, in the case where the design value is equal to or larger than the target value in all of the target area (Y in operation AH), the determining unit 25 advances to operation AI. In the case where there is an area where the design value is not equal to or larger than the target value (N in operation AH), the routine returns to the operation AC. After that, in the area where the design value is not equal to or larger than the target value, the operations AC to AG are repeated. In this case, both of the new site added in the previous operations AD to AF and the existing sites are regarded as existing sites.

In operation AI, the determining unit 25 determines whether the design value is equal to or larger than the amount of traffic in all of the target area. In the case where the design value is equal to or larger than the amount of traffic (Y in operation AI), the routine advances to operation AJ. In the case where there is an area where the design value is not equal to or larger than the amount of traffic (N in operation AI), the routine returns to the operation AC. After that, in the area where the design value is not equal to or larger than the amount of traffic, the operations AC to AG are repeated. In this case, both of the new sites added in the previous operations AD to AF and the existing sites are regarded as existing sites. In operation AJ, the data output unit 26 outputs design data which designates setting of the existing sites and the new sites. After that, the operation is finished.

1.4 Example of Design Work

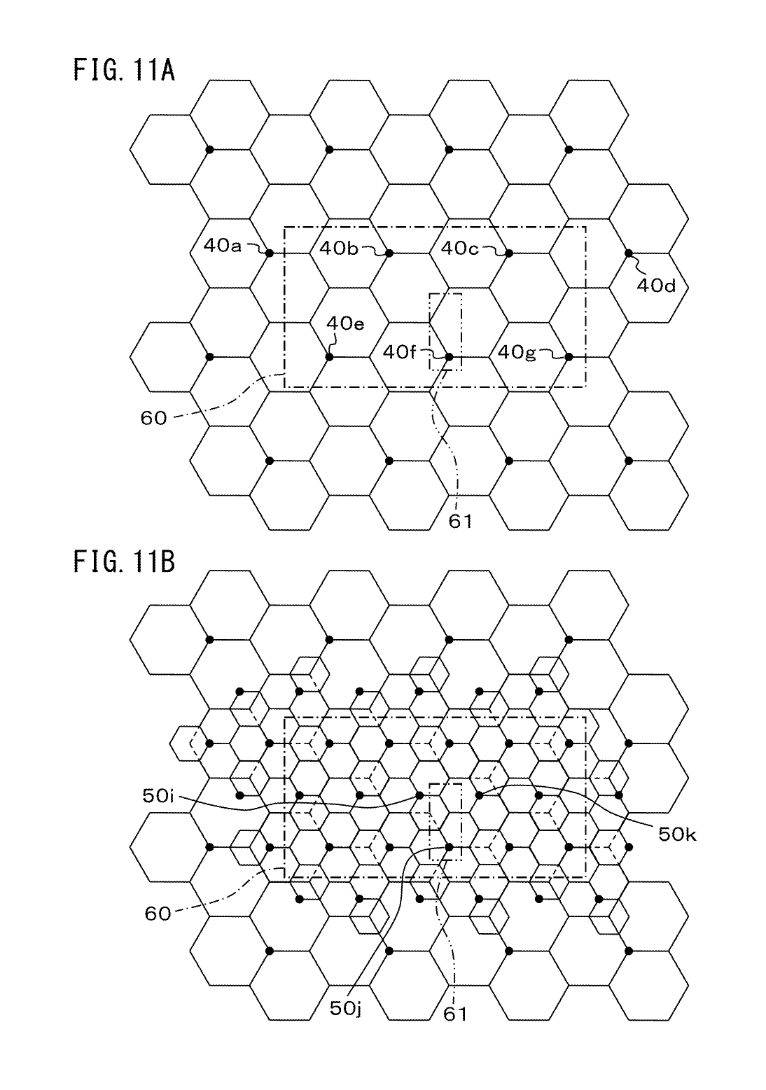

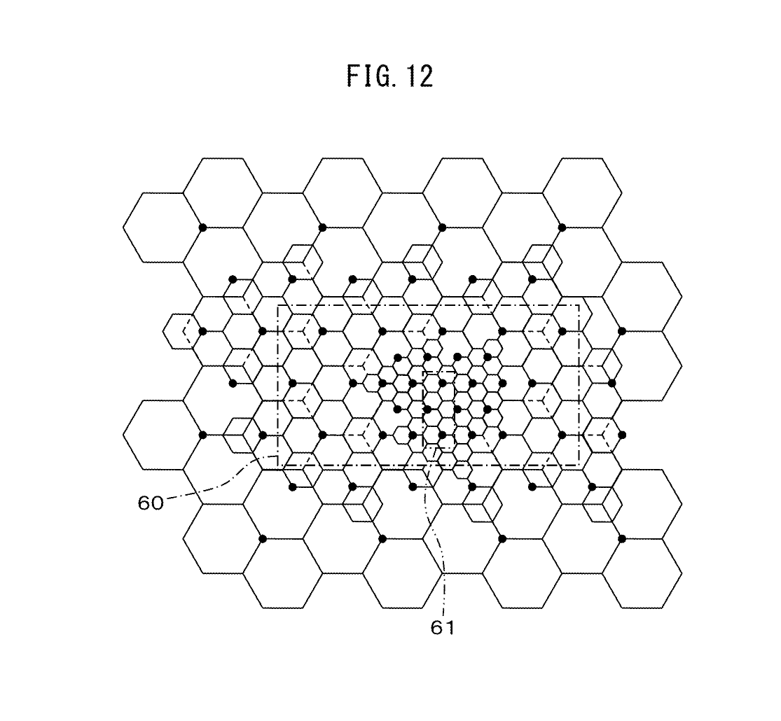

With reference to FIGS. 11A and 11B and FIG. 12, an example of a work of designing a wireless communication network area will be schematically described. FIG. 11A illustrates a site placement of a wireless communication network before new sites are added. An area surrounded by an alternate long and short dash line 60 indicates a capital region area 60 and an area surrounded by an alternate long and two short dashes line 61 indicates a downtown area in the capital region area.

It is now predicted that the amount of traffic in the capital region area 60 will become three times in three years and the amount of traffic in the downtown area 61 will become ten times in three years. The setting target values of the traffic capacity are set to three times and ten times of the present design values in the capital region area 60 and the downtown area 61, respectively.

First, regarding cells in the sites 40a to 40g covering the capital region area 60, reduction in the cell radius in the existing sites 40a to 40g and addition of new cells are performed once in accordance with the area designing method. FIG. 11B illustrates a state where new sites are added. Since the density of sites in the capital region area 60 becomes four times, the traffic capacity is increased to four times. Therefore, at this time point, the goal in the capital region area 60 is achieved.

On the other hand, in the downtown area 61, increase in the traffic capacity does not reach ten times as the target value. Consequently, in the cells of the sites 50i, 50j, and 50k covering the downtown area 61, reduction in the cell radius in the sites 50i, 50j, and 50k and addition of new cells are performed again. FIG. 12 illustrates a state where new cells are added. As a result, the traffic capacity in the downtown area 61 increases to 16 times (4×4) as compared with the state of FIG. 11A before sites are added. Therefore, the goal in the downtown area 61 is also achieved, and the design work in the all of the target area is completed.

1.5 Effect of First Embodiment

According to the first embodiment, the method of setting site location and cell radius efficiently and regularly to deploy cells without gaps, which can be used to add sites while using existing sites is provided. As a result, the work of designing a seamless network becomes easier, so that the efficiency of the design work is improved. It reduces the investment cost for adding sites. Since the proposed method make use of the existing sites to a great extent, the existing facilities of power supply, equipment room, air conditioner etc. can be utilized mostly. Thus, reduce the investment cost comparing with using an entirely new site for capacity increase.

### 2. Second Embodiment

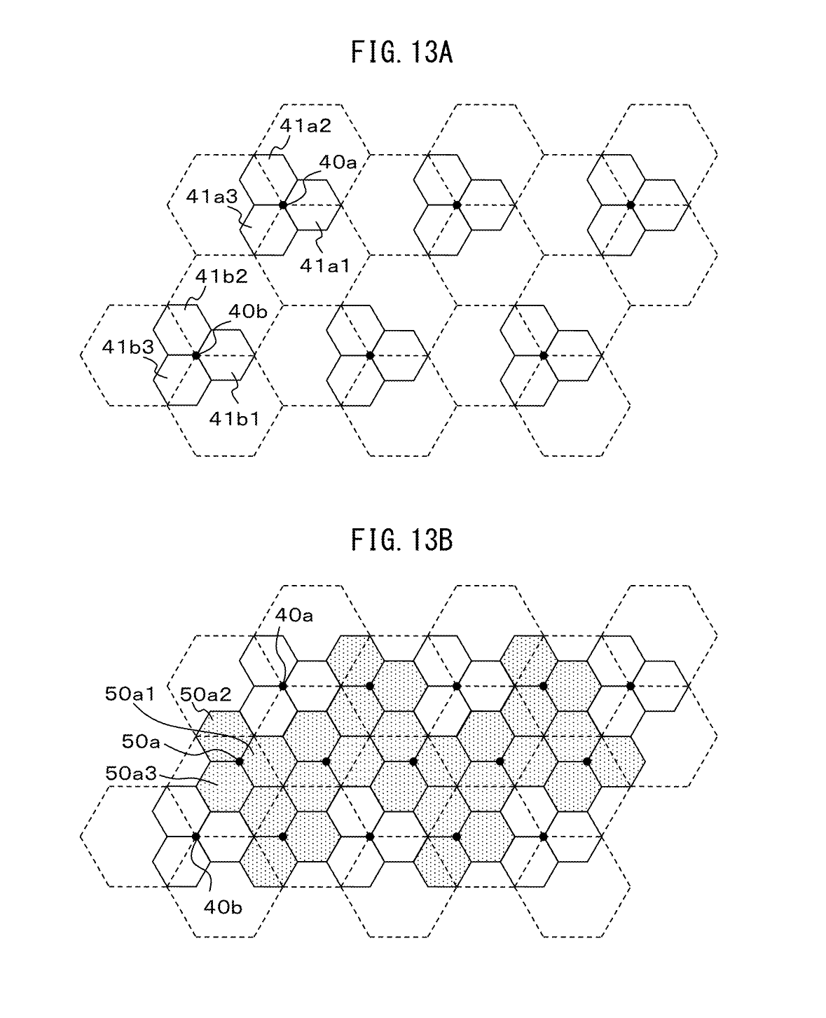

Subsequently, another embodiment of the area designing method and the area designing device 10 will be described. FIGS. 13A and 13B are diagrams illustrating a second example of the area designing method. FIG. 13A illustrates a state where the cell radius of the existing sites 40a and 40b is reduced to R/2 at the time of adding new sites.

In the embodiment, at the time of adding new sites, the antenna azimuth angles of the existing sites 40a and 40b are turned by 60 degrees in the clockwise or counterclockwise direction. As compared with the state of the sectors of the first embodiment depicted in FIG. 2B, the sectors 41a1 to 41a3 and the sectors 41b1 to 41b3 in FIG. 13A are in positions turned by 60 degrees in the clockwise direction.

Next, the installation positions of the new sites are determined. FIG. 13B illustrates a state after the new sites are determined. In a manner similar to the first embodiment, the positions of new sites are set to positions on the straight line connecting a pair of adjacent existing sites and apart from the existing sites by equal distances. The antenna azimuth angles of the new sites are also aligned to those of the existing sites 40a, 40b, . . . in a manner similar to the first embodiment.

In a manner similar to the first embodiment, the cell radius of the new site is set to R/2 which is the same as the cell radius of the existing cites 40a and 40b after reduction of the cell radius. Also by setting the antenna azimuth angle and cell radius of an existing site and the installation position, antenna azimuth angle, and cell radius of a new site in such a manner, the cells can be efficiently deployed without gaps in a manner similar to the first embodiment.

FIG. 14 is a diagram illustrating the second example of the functional configuration of the area designing device 10. The same reference numerals as those used in FIG. 6 are designated to components similar to the components depicted in FIG. 6. The area designing device 10 has an antenna azimuth angle changing unit 28. At the time of adding a new site, the antenna azimuth angle changing unit 28 turns the antenna azimuth angle of an existing site by 60 degrees in the clockwise or counterclockwise direction. The operation of the antenna azimuth angle changing unit 28 is realized by the processor 11 illustrated in FIG. 11.

FIG. 15 is a diagram illustrating a second example of the operation of the area designating device 10. Operations BA to BC are similar to the operations AA to AC in FIG. 10. In operation BD, the antenna azimuth angle changing unit 28 turns the antenna azimuth angle of the existing site by 60 degrees. Operations BE to BK are similar to the operations AD to AJ in FIG. 10. The order of the operations BC to BG is not limited to that in FIG. 10. The operations BC to BG may be executed in any order.

Also by the embodiment, the method of setting site location and cell radius efficiently and regularly to deploy cells without gaps, which can be used to add sites while using existing sites is provided. In the second embodiment, the cell arrangement using an antenna azimuth angle different from that in the first embodiment can be designed. Consequently, a designer can select any cell arrangement using the antenna azimuth angle which is more preferable in accordance with an actual radio wave state and the conditions of the existing sites.

The method, the computer-readable, non-volatile medium storing a computer program, or the device disclosed in the specification facilitates seamless cell designing in which the number of sites and the number of gaps among cells is optimized at the time of adding a site.

All examples and conditional language recited herein are intended for purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A wireless communication network area designing method for determining the location of a site in which a wireless base station formed by a three-sector configuration is to be installed in an area, comprising:
reducing cell radius of existing sites to the half;
adding a new site to an intermediate point between adjacent existing sites;
aligning an antenna azimuth angle of the new site to antenna azimuth angle of the existing sites; and
setting a cell radius of the new site to be the same as the cell radius of the existing sites in the reduced cell radius.

2. The wireless communication network area designing method according to claim 1, further comprising:
changing the antenna azimuth angle of the existing sites so as to be turned by 60 degrees,
wherein aligning an antenna azimuth angle, the antenna azimuth angle of the new site is aligned with the antenna azimuth angle of the existing sites.

3. The wireless communication network area designing method according to claim 1, further comprising: specifying an area in which the amount of traffic after reducing cell radius, the addition of a new site, aligning an antenna azimuth angle, and the setting of a cell radius when the designed capacity is lower than desired traffic capacity,
wherein in the specified area, while regarding a new site added in the site adding step as existing sites in addition to the existing sites, the reducing cell radius, the adding a new site, the aligning an antenna azimuth angle, and the setting a cell radius is lower than desired traffic amount are repeated.

4. The wireless communication network area designing method according to claim 2, further comprising: specifying an area in which the traffic amount after reducing cell radius, changing the antenna azimuth angle, adding a new site, aligning an antenna azimuth angle, and the setting of a cell radius when the designed capacity is lower than desired traffic capacity,
wherein in the specified area, while regarding a new site added in the site adding step as existing sites in addition to the existing sites, the reduction of cell radius, the change of the antenna azimuth angle, the addition of a new site, the aligning of an antenna azimuth angle, and the setting of a cell radius are repeated.

5. A computer-readable, non-volatile medium storing a computer program for causing a computer to determine allocation of a site in which a wireless base station formed by a three-sector configuration is to be installed in an area, wherein the computer program causes a processor to execute a process, the process comprising:
accepting input of site information including at least positions of existing sites, cell radius of the existing sites, and antenna azimuth angle of the existing sites;
reducing a set value of the cell radius of the existing sites to the half;
designating an intermediate point of adjacent existing sites as a place of adding a new site;
aligning a set value of the antenna azimuth angle of the new site with the antenna azimuth angle of the existing site; and
setting a set value of a cell radius of the new site to be the same as the cell radius of the existing sites in the reduced set value of the cell radius.

6. A wireless communication network designing device which determines the location of a site in which wireless base station formed by a three-sector configuration is to be installed in an area, comprising:
an input unit which accepts input of site information including at least positions of existing sites, cell radius of the existing sites, and antenna azimuth angle of the existing sites;
a cell radius reducing unit which reduces a set value of the cell radius of the existing sites to the half;
a site adding unit which designates an intermediate point of adjacent existing sites as a place of adding a new site;
an antenna setting unit which aligns a set value of the antenna azimuth angle of the new site with the antenna azimuth angle of the existing site; and
a cell radius setting unit which sets a set value of the cell radius of the new site to be the same as the cell radius of the existing sites reduced by the cell radius reducing unit.
